(19) United States
(12) Patent Application Publication
(10) Pub. No.: US 2012/0155224 A1
(43) Pub. Date: Jun. 21, 2012

(54) WATERPROOF WRIST WORN ELECTRONIC DEVICE

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 13/071,454

(22) Filed: Mar. 24, 2011

(30) Foreign Application Priority Data
Dec. 21, 2010 (TW) 99145088

(51) Int. Cl. G04B 19/00; G06F 3/041

(52) U.S. Cl. 368/223; 345/173

(57) ABSTRACT

A wrist worn electronic device includes a hollow casing including an internal protruding tab defining a groove. A display panel is arranged within the hollow casing. A touch panel is arranged on the display panel and is larger than the display panel. The touch panel includes a margin portion around the display panel and rests on the protruding tab. The margin portion is connected to the protruding tab by waterproof adhesive. The groove accommodates waterproof adhesive to form a sealing layer to prevent water from entering the casing.

### BACKGROUND

1. Technical Field

The present disclosure relates to a waterproof wrist worn electronic device.

2. Description of Related Arts

Watches are commonly used and usually have a waterproof structure. For many watches, there is still a need for a new waterproof structure.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a wrist worn electronic device according to an embodiment.

FIG. 2 is an isometric, exploded view of the wrist worn electronic device of FIG. 1.

FIG. 3 is a cross-sectional view of the wrist worn electronic device of FIG. 1, taken along line III-III of FIG. 1.

### DETAILED DESCRIPTION

Embodiments of the present disclosure will now be described in detail below, with reference to the accompanying drawings.

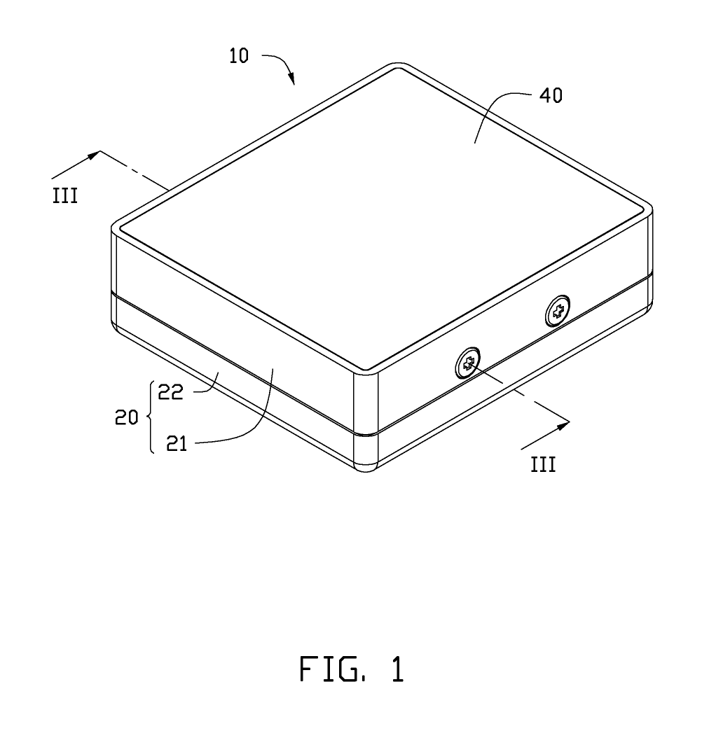

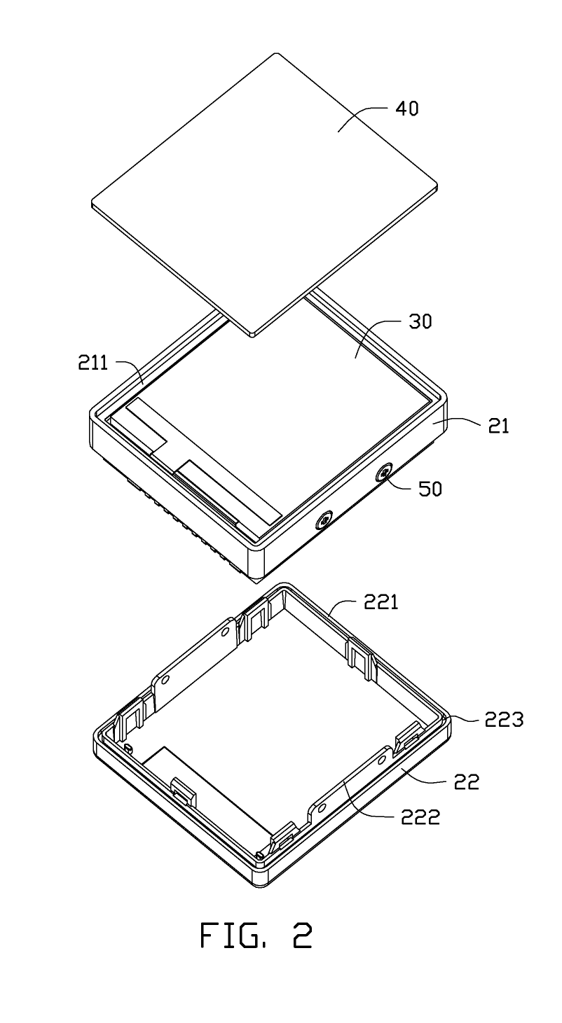

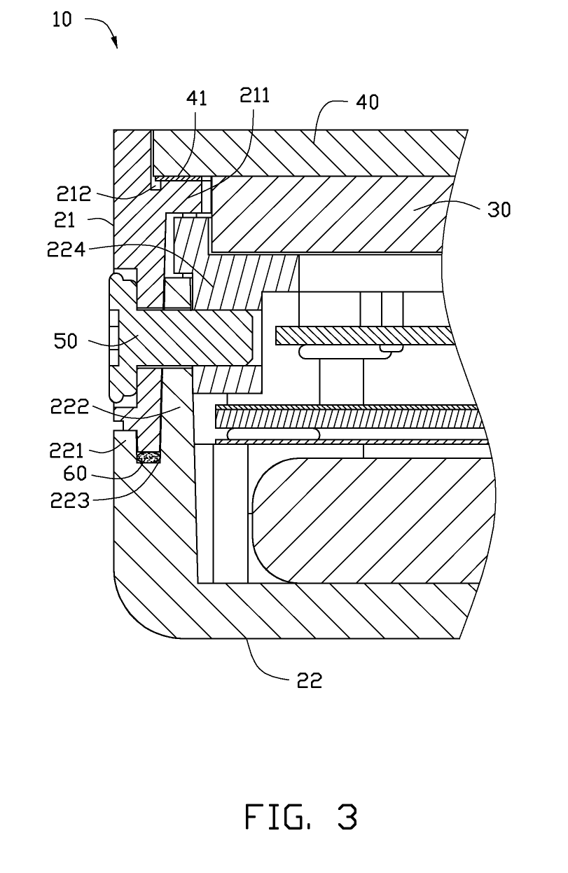

Referring to FIGS. 1-3, a wrist worn electronic device 10 includes a casing 20, a display panel 30, and a touch panel 40 arranged on the display panel 30. In the embodiment, the electronic device 10 can be a watch.

The casing 20 includes an upper casing 21 and a lower casing 22. The upper casing 21 is a hollow frame including a number of sidewalls that cooperatively define a hollow space to receive the display panel 30, the touch panel 40, and other required electronic components. A protruding tab 211 is formed on the inner lateral surface of the upper casing 21. A groove 212 is formed in the protruding tab 211 and extends all around the protruding tab 211.

The lower casing 22 includes a number of sidewalls and a first protruding wall 221 and a second protruding wall 222, which both protrude from the top of the sidewalls and extend all around the edges of the sidewalls. The second protruding wall 222 is higher than the first sidewall 221. A groove 223 is formed between the first and second walls 221 and 222. The groove 223 is set to allow the upper casing 21 to fit therein.

In the embodiment, one end of the upper casing 21 is received in the groove 223 of the lower casing 22. An O-ring 60 is arranged in the groove 223 and used to prevent water from entering into the casing. In the embodiment, a waterproof screw 50 extends through the sidewall of the upper casing 21 and the second protruding wall 222 and is screwed into a support member 224 in the lower casing 22, which fixes the upper casing 21 to the lower casing 22.

The display panel 30 is received in the upper casing 21 and rests on the support member 224. The touch panel 40 is larger than the display panel 30. That is, the touch panel 40 includes a margin portion 41 that is located around the display panel 30. The margin area 41 rests on the protruding tab 211. In the embodiment, the margin portion 41 is affixed to the protruding tab 211 by waterproof adhesive. A sealing layer is thus formed between the touch panel 40 and the upper casing 21. Furthermore, the groove 212 in the protruding tab 211 can be used to accommodate waterproof adhesive to form another sealing layer between the sidewall of the upper casing 21 and the touch panel 40.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A wrist worn electronic device comprising:
a hollow casing comprising an internal protruding tab defining a groove;
a display panel arranged within the hollow casing;
a touch panel arranged on the display panel and being larger than the display panel, the touch panel comprising a margin portion around the display panel and resting on the protruding tab, the margin portion being connected to the protruding tab by waterproof adhesive;
wherein the groove accommodates waterproof adhesive to form a sealing layer to prevent water from entering the casing.

2. The wrist worn electronic device according to claim 1, wherein the casing comprises an upper casing and a lower casing, the lower casing defines a receiving groove and a bottom end of the upper casing is received in the receiving groove.

3. The wrist worn electronic device according to claim 2, wherein an O-ring is received in the receiving groove to prevent water from entering the casing.

4. The wrist worn electronic device according to claim 2, wherein the lower casing comprises a first protruding wall and a second protruding wall, the receiving groove is formed between the first protruding wall and the second protruding wall, the upper casing is fixed to the second protruding wall by a waterproof screw.

5. The wrist worn electronic device according to claim 1, wherein the wrist worn electronic device is a watch.
